(19) United States
(12) Patent Application Publication
(10) Pub. No.: US 2002/0198291 A1
(43) Pub. Date: Dec. 26, 2002

(54) High performance elastomer-containing concrete material

(76) Inventor: David Yakovlevich Frenkel, West Bloomfield, MI (US)

Correspondence Address: WINSTON & STRAWN, PATENT DEPARTMENT, 1400 L STREET, N.W., WASHINGTON, DC, 20005-3502, US

(21) Appl. No.: 10/039,473

(22) Filed: Jan. 4, 2002

Related U.S. Application Data
(60) Provisional application No. 60/259,711, filed on Jan. 5, 2001.

(51) Int. Cl. C08K 5/16; C08K 3/34

(52) U.S. Cl. 524/2; 524/492

(57) ABSTRACT

A concrete material that includes an elastomeric polymer in an amount sufficient to provide flexibility to the resultant material; a silicone resin in an amount sufficient to improve adhesion between the elastomeric polymer and the cement; a cement that has low shrinkage and expansion properties; a filler; and water in an amount sufficient to cure the cement and form the concrete material. The polymer is present in an amount which fills at least some of the pores in the material and the silicone resin helps the polymer bond the filler to the cement. Also, a concrete material property improving additive in the form of a polymer admixture that includes the elastomeric polymer, a silicone resin and at least one solvent in an amount sufficient to form a viscous flowable mass. Another embodiment is a method of forming a concrete material by forming and curing a mixture of the additive, a cement that has low shrinkage and expansion properties, a filler, and water in an amount sufficient to cure the cement. Another embodiment is a method of repairing a crack or fracture in a concrete or cement surface by cleaning surfaces of the crack or fracture to remove loose material and to create a cavity, applying the concrete material of the invention under pressure into the cavity, and allowing the concrete material to cure to repair the crack or fracture. The resultant repaired surface forms yet another embodiment of the invention.

### CROSS-REFERENCE TO RELATED APPLICATIONS

This application claims the benefit of provisional application No. 60/259,711 filed Jan. 5, 2001, the content of which is expressly incorporated herein by reference thereto.

### BACKGROUND

The present invention relates to a high performance concrete material for use in repairing construction materials such as those used in roads, airport runways, bridge decks, parking garages and the like. The invention can also be used as a specialty construction material for use in high service demand applications.

A common, conventional construction material is concrete, and it is used in a variety of places due to its high strength as well as its wear and abrasion resistance. Over time, environmental conditions and use cause these construction materials to wear, abrade, crack or otherwise degrade, thus necessitating repair or replacement to restore them to their original condition. If the same or a similar material is utilized to patch holes or cracks in such materials, the patching material can shrink upon curing, disbond and become dislodged. For this reason, specialty cement and concrete repair materials have been developed, primarily with the goal of providing a material having a similar hardness and strength but with low shrinkage or expansion properties in order to reduce the tendency of the repair material to dislodge when the structure is placed back into service. For this reason, many of these materials utilize a low shrinkage or low expansion cement, often in a quick setting formulation to facilitate the repair and create a patch that will endure when the patch is subjected to stresses after being placed back in use.

Despite the success of such specialty repair materials, there are situations where the repair materials must also provide enhanced properties due to the high service demands of the construction material. For example, airline runways experience a high degree of stress due to airplane landings, and bridge structures experience flexure and variable forces due to the movement of vehicles across the structure. In addition to being compatible with the material of the structure to be restored, the repair material should possess properties that can withstand such high service demands. The present invention now discloses new formulations and concrete materials that possess desirable properties which make them eminently suitable for use as repair materials, along with methods for repairing structures utilizing such materials.

### SUMMARY OF THE INVENTION

The present invention relates to concrete materials that contain various polymer additives therein which react with the cement and water in the material to form high strength, flexible, monolithic structures that can be used as load bearing surfaces, such as roadways or airport runways, as cast or molded shapes, such as bars, rods, or other articles, or as repair material to fill cracks, holes or other defects in cement or concrete structures.

The concrete materials of the present invention typically contain the following components as ingredients of a concrete material forming formulation:

(1) an elastomeric polymer, preferably one that is in liquid form and that is reactive with the cement or water that is included in the material, such as an elastomer polymer comprising a polysulfide polymer (i.e., a liquid thiokol rubber) or a polyurethane polymer;

(2) a silicone resin in an amount sufficient to improve adhesion between the elastomeric polymer and the cement;

(3) a cement that has low shrinkage and expansion properties, such as an alumina, sulfoalunima, or sulfoferritic cement, and preferably one having an expansion rate of less than about 0.5% and more preferably less than about 0.3%;

(4) a filler material of the type generally utilized in cement or concrete manufacture, and preferably sand; and

(5) water in an amount sufficient to cure the cement.

In these compositions, the elastomeric polymer is generally present in an amount of about 4 to 14 and preferably 7 to 11 percent by weight, the silicone resin is generally present in an amount of about 0.05 to 2 and preferably about 0.1 to 1 percent by weight, the low shrinkage cement is generally present in an amount of about 4 to 17 and preferably 10 to 15 percent by weight, and the filler represents the balance and is typically present in an amount of about 60 to 91 percent by weight. All weights mentioned in this paragraph are calculated on the total weight of the material except for the amount of water. Generally, the amount of water is present in a water-to-cement weight ratio of between about 0.05 and 0.1 although this can be varied depending on how the material is to be applied.

### DETAILED DESCRIPTION OF THE PREFERRED EMBODIMENTS

The compositions of the present invention have widespread application in industrial, civil and hydraulic construction engineering projects. In particular, the invention is most useful as a new roadway pavement, bridge deck or airport runway surface, or for repairing cracks and fractures in such surfaces.

The concrete materials of the invention contain an elastomeric polymer as this component imparts flexibility and elasticity to the concrete materials. While it is possible to add the polymer as a powder, it is preferred to add it as a liquid as this facilitates the dispersion of the polymer throughout the material. Also, it is advantageous for the polymer to be reactive with the cement or water that is included in the material. Preferred elastomeric polymers include polysulfide polymers such as liquid thiokol rubbers. Also, polyurethane polymers can be used, preferably those that are made with excess isocyanate functionality so that the polymer is reactive with water that is present in the concrete material formulation. The molecular weight of the elastomeric polymer is not critical but should be between about 1,000 and 8,000 g/mol.

The elastomeric polymer is generally present in an amount sufficient to increase the flexibility and deformability of the concrete material. This amount will depend upon the specific polymer that is utilized and the form in which it is added to the formulation. The useful amounts of any particular polymer can be determined by routine experimentation. The polymer should be present in an amount that fills at least some of the pores in the material, at least partially contacts the filler and helps bond the filler to the cement. Generally, the polymer will be present in an amount of between about 4 and 14 and preferably 7 to 11 percent by weight of the concrete material.

When a hardener or curing agent is used for the elastomeric polymer, it is preferred to utilize vulcanizing substances such as bichromates of calcium, sodium or other alkali or alkaline earth metals, alone or in combination with oxides of lead, manganese or other transition metals. These hardeners or curing agents can be included in an amount of between about 0.1 and 0.5 and preferably between about 0.2 and 0.3 percent by weight. Generally, vulcanization or hardening occurs at room temperature and no special heating is required. During the addition of the water and non-shrinking cement to the formulation, the vulcanization rate increases rapidly due to the presence of the highly alkaline medium.

For the intended applications and purposes of use of the inventive compositions, the polysulfide polymer is modified by the addition of a silicone resin to increase the adhesive properties of that polymer. These silicone resins contain, in their structure, functional groups such as vinyl, epoxy, amine, thiol, etc., which are able to react with the —SH groups of the polysulfide polymer. These resins also react with alkoxy groups which are able to hydrolyze in the presence of moisture or water to form reactive silanol groups. Those groups in turn take an active part in the formation of chemical bonds with the silica of the filler and with polymineral substrates such as concrete, brick, glass and metal. A preferred silicone resin is one that has the structure HS—R—Si(OR′)₃ where R is a straight or branched alkyl group of 1 to 10 carbon atoms and R′ is a group which is reactive such as -NH, vinyl, epoxy, —SH, and the like. These silicone resins, when used, are added in an amount which is effective to promote compatibility between the cementitious components and the elastomeric polymer, such as preferably between about 0.05 and 2% and more preferably about 0.1 to 1% by weight of the composition.

The concrete material formulations of the invention also contain a cement that imparts hardness and wear and abrasion resistance to the final concrete material. A cement that has low shrinkage and expansion properties, such as an alumina, sulfoalunima, or sulfoferritic cement, is preferred. The preferred cements have an expansion rate of less than about 0.5% and more preferably less than about 0.3%. The cement is generally present in the concrete material in an amount of about 4 to 17 and preferably 10 to 15 percent by weight.

The concrete materials of the invention also contain a filler component of the type generally utilized in cement or concrete manufacture. Any type of filler can be used, but sand is preferred. The sand should be clean and have a grain size of between about 2.7 and 3.1 mm in order to form a concrete material in the form of particles, some of which are sticky. The use of other fillers may be required for certain applications. For example, granite particles can be used when a very hard surface is required. Other filler materials known to one of ordinary skill in the art, such as aggregate, glass, silica, talc, carbon black, and the like can be used as desired either alone or in various combinations of one or more of these materials. The specific size of the filler and the optimum amount to use can be determined by routine testing. The filler is included in the formulation or final concrete material as the balance of the solids, and generally in an amount of about 60 to 91 percent by weight.

The amount of water in the uncured concrete material will generally be between about 1 and 25% by weight. The higher amounts (i.e., between 10 and 25%) of water enable the material to be sprayed or gunited, while lower amounts (i.e., between 1 and 7%) provide a longer working time to apply the material before it cures. These amounts of water generally provide a water-to-cement weight ratio of between about 0.05 and 0. 1, ratios that are useful for most applications of the concrete material to a substrate or in a repair of another material.

The previously described embodiments of the components of the present invention have as their physiochemical base the interaction of the cement, filler, and water components with the parallel formation of a high molecular weight polymeric matrix in the structure of the concrete material. The combination of the presence of both polymeric and cementitious matrices contributes to the enhanced properties of the concrete material, and in particular to the combination of hardness, waterproofness, and flexibility.

When water is added to cement, the minerals contained therein, such as C₂S, C₃S, C₄AF, C₃A, C₂FCS and others, react to form crystal and gelatinous masses, thereby causing hydration reactions which are accompanied by the liberation of free lime. This creates the highly alkaline medium for the formulation of such crystals and gelatinous masses.

Calcium hydrosilicates are initially formed as a rule in a gelatinous form, while calcium hydroxide and calcium aluminate are formed as crystals which permeate the gel mass of hydrosilicates. The polymer that is included in these formulations contacts the cement particles and sufficiently coats or covers the surfaces of such particles, thus appearing between the gelatinous hydrosilicates and the hydroxide/aluminate crystals. The polymer itself appears to be reinforced by the crystal phase the hydrated cement, with the calcium hydroxide formed during hydration due to the high level of alkalinity then acting as an accelerator for the vulcanization or hardening of the polymer. As a result, the growth of crystals formed during hydration of the cement takes place through a hardened polymeric film or layer which results in the enhancement of some of the mechanical characteristics of the final concrete material. In general, the resulting heterogeneous system of cement, sand and polymer has much better elasticity and flexibility when subjected to mechanical loads compared to conventional concrete materials. Also, the present inventive material has much better adhesion to concretes, cements, asphalts and other building materials compared to conventional concretes, cements, asphalts or other patching materials.

The concrete materials of the invention possess the following advantages over conventional concrete materials:

higher deformability

higher elasticity and flexibility

higher waterproofness

increased strength of cohesion of the components in the material

increased corrosion resistance

increased resistance to low temperatures

A further comparison is illustrated in Table I. As noted above, the higher strength of the concrete material of the invention is provided by the higher level of cohesion between the cement, filler and polymer, and a reduced porosity of the resulting concrete material. Also, the interaction of metal oxides with the polysulfide oligomer, along with the interaction of the residual water and cement leads to the strengthening of the material.

TABLE I
Pore Structure Comparison

| | Total porosity | Volume of pores (in %) with radius of: | | |
|---|---|---|---|---|
| Material | % | 3-5 nm | 5-100 nm | over 100 nm |
| conventional | 26.4 | 5 | 43 | 52 |
| concrete | | | | |
| concrete of | 7.2 | 12 | 65 | 23 |
| the invention | | | | |
| (useful | 2-20 | 7-20 | 50-75 | 18-30 |
| inventive | | | | |
| range) | | | | |

As a result of the change in pore structure, i.e., the reduction of large pores and increase of small and medium pores, the concrete material of the present invention possesses a high degree of waterproofness, and an increased resistance to cold temperatures, weathering, wear and abrasion.

In conventional concrete, the bond of the filler with the cement matrix occurs along the contact zone between those components due to the presence of calcium hydroxide and calcium hydrosilicates at those contact zones. Due to the presence of the polymer in the concrete materials of the present invention, this bond is improved because any pores in the contact zone are filler by the polymer, thus coating the surfaces of the filler and in effect gluing the filler to the hydrated cement particles.

The role of cohesion is explained by the fact that the liquid phase of the cement, which is generally made up of the polymer particles, calcium ions, and aluminate and silicone anions, penetrates into the pores of the material, and the processes of hydration and polymerization, which take place, cause the components to strongly bond together.

Thus, during hardening of the concrete material of the invention, both formation of the polymer network and water hydration of the cement occur, so that the modulus of elasticity is significantly increased thus essentially preventing propagation of cracks and increasing the resistance of the material to impact or variable force loads.

Conventional cement compositions that contain polymers are often subject to shrinkage. Of course, such shrinkage is disadvantageous when the concrete material is utilized as a patching or repair material. Thus, the present invention preferably includes an expansible component of gypsum alumina or sulfoferrite cements to offset shrinkage caused by the formation of ettringite or ferrous ettringite under the following reactions:

3CaAl₂O₃+CaSO₄×2H₂O+29H₂O→3CaOAl₂O₃×3CaSO₄×31H₂O+ΔV

2CaO×Fe₂O₃×CaSO₄+31H₂O→2CaO×Fe₂O₃×3CaSO₄×31H₂O (ferrous ettringite)+ΔV

The polymer that is added to the present formulations and materials has good ahdesion to cement hydration products so that it coats and covers them, providing stability of ettringite with its recrystallization into a monosulfate form, the latter of which is characteristic for conventional cement and concrete products which do not contain expansible additives. In general, this compensates for shrinkage of the present concrete materials as they cure. The polymer also changes the pore structure of the concrete material by filling pores. This polymer filling along with the adhesion of the polymer to the products of hydration of the cement increases the waterproofness, sulfate resistance and resistance to cold temperatures for the concrete materials of the invention.

The concrete materials can be prepared by a number of different methods. In one method for preparing these materials, a polymer admixture is first prepared by mixing the elastomeric polymer and silicone resin with a solvent or solvent mixture to form a viscous flowable mass. To do this, the elastomeric polymer is heated to about 30° C. to 60° C., and the silicone resin and solvent(s) are mixed therewith to form an admixture. The elastomeric polymer is present in the admixture in an amount of about 70 to 98% by weight while the silicone resin is present in an amount of about 2 to 30%. The amount of solvent used is that which solubilizes these ingredients into a homogenous viscous mass. Any of a wide range of organic solvents can be used, including aromatic or aliphatic solvents. Mixtures of aromatic and aliphatic solvents are preferred so that a homogenous mass can be obtained. One preferred solvent mixture is a mixture of between 30 and 40% by weight of each of xylol, tolylol and butyl acetate. One of ordinary skill in the art can readily determine other suitable solvent combinations by routine testing.

The admixture and low shrinkage cement are then mixed together with the water to form a raw material that can be processed in a manner similar to asphalt. The mixed combination can be deposited on a roadbed or into a crack or pothole under pressure of, for example about 400 Kg/cm², to form a hard durable surface that is capable of receiving loads and is ready for use. Also, cement-like shaped components can be made by molding the mixed combination under pressure in a mold that is configured to the size and shape of the final component. In this way, rods, blocks, or other shapes can be made.

During mixing of the polymer with the cement and sand components, the polymer is able to penetrate into the pores of the cement and fills them. This is particularly true when the polymer is added in a liquid form. The location of the polymer in the filled pores accelerates the vulcanization process for the polymer due to the highly alkaline adjacent medium of wet cement. The polymer rapidly polymerizes at room temperatures to provide a highly dense solid material. In effect, the sand particles are glued to the cement matrix by the relatively flexible polymer. The silicone resin contributes to the adhesivity of the polymer for this purpose. In addition to the enhancement of properties of the final material, the polymer acts as a thickening agent for the cement, in essence creating a high quality concrete.

Research of the boundary surfaces between the cement, filler particles and the polymer shows that the polymer forms a partial or full coating on the surface of the particles of hydrated cement and sand, and this creates the dense and firm adhesive bonds between the cement and sand. The presence of calcium ions is necessary for forming optimum cohesion between the components, and this confirms the role of these cations in the creation of a bond between negative ions on the surfaces of the sand particles and the charged centers on the surfaces of the polymer particles.

Another way to form the concrete materials of the invention includes the steps of heating the filler, preferably sand, to about 40° C. to 60° C., and also heating the elastomeric polymer to a temperature of about 40° C. to 60° C. Thereafter, the heated filler and elastomeric polymer are thoroughly mixed together, preferably while keeping the temperature in the range of about 30° C. to 60° C. Next, the low shrinkage cement is added with a small amount of water, i.e., one that provides a water/cement weight ratio of between about 0.05 to 0.1, and is thoroughly mixed therein. Finally, the silicone resin is added thereto and thoroughly mixed in, optionally with a hardener for the elastomer polymer, if necessary, to form a raw material that can be processed in a manner similar to asphalt. This procedure does not require the use of any solvents and results in a mixed combination that can be deposited on a roadbed under pressure of, e.g., about 400 Kg/cm², to form a hard durable surface that is capable of receiving loads and is ready for use. Again, cement-like shaped components can be made by molding the mixed combination under pressure in a mold that is configured to the size and shape of the final component (i.e., rods, blocks, or other shapes).

When using the concrete materials of the invention for repairing a crack or fracture of an existing cement or concrete structure, the defective area is removed with the remaining surfaces cleaned of debris. A primer, preferably of a polysulfide or thiokol-containing compound, is then applied to the cleaned surfaces, and the space between the surfaces is filled with the concrete material of the invention. This material is then subjected to pressure or is compressed for a sufficient time to allow the material to completely fill the space and provide a hard, durable patch therein. The patch is securely bonded to the surfaces and is not likely to become dislodged because of the low shrinkage cement that is included in the material.

According to the present invention, the following components may be used for the primer of the thiokol-containing compound (wt. %):

| | |
|---|---|
| liquid thiokol | 80-120 |
| inorganic pigment | 20-45 |
| vulcanizer of aerobic rubber hardening | 6.5-10.0 |
| adhesive additive | 5.5-7.5 |
| rubber hardener | 0.05-0.15 |
| cross-linking agent | 2.6-4.1 |
| modifier | 0.3-0.4 |
| silicone resin | 4.5-31.2 |

This compound is typically applied to the surfaces as a layer that is between about 0.1 to 2 mm thick. Once a layer of the compound has been applied to the crack or holes in the construction material to be repaired, it is necessary to immediately fill the crack or hole with one of the concrete materials of the invention.

The hardening of the cement components and the vulcanization of the polysulfide polymer occur simultaneously. In fact, the elastomeric polymer, silicone resin, the cement and the water simultaneously react due to the alkaline medium of the cement stone and the presence of oxides, i.e., CaO, Al₂O₃, and Fe₂O₃ therein, which are capable of producing a vulcanizing and strengthening effect on the polysulfide and silicone resin. Vulcanization and strengthening of the elastomeric polymer are additionally promoted due to the presence of the water that is added to the mixture as well as to that which is released during vulcanization of the polymer.

Depending upon the amount of water that is included in the overall formulation, the concrete formulations can be applied in the same manner as concrete or cement or can be provided as a viscous mass that can be troweled, sprayed or gunited onto a surface that is to be repaired or protected.

After the cement hardens, the resulting material possesses monolithic characteristics, and patches or repairs made using this material act as an integral unit. These structures are watertight at their joints, and can withstand, without failure, cyclic tensile and compression loads, heating and cooling cycles, and are anti-seismic.

A further embodiment of the present invention relates to constructing roads and highways utilizing the concrete materials described herein. As noted above, this material can be processed and applied in essentially the same way as asphalt.

### EXAMPLES

The following examples illustrate the most preferred formulations for preparing concrete materials in accordance with the present invention.

### Example 1

A preferred formulation for the cement material of the invention is as follows:

| component | parts |
|---|---|
| liquid thiokol | 9 |
| sand | 76.7 |
| low shrinkage cement mix | 13 |
| silicone resin | 1 |
| hardener | 0.3 |

After being mixed as described above and deposited under a pressure of about 400 kg/cm², the material provides a hard concrete-like surface that is immediately ready for use after deposition. This material gains strength over time and exhibits very little shrinkage, expansion or other deformation, even under heavy loads. Generally, there is very little if any deformation under small loads, with a small, relatively constant expansion under heavier loads. These properties make the material extremely useful in a variety of repair applications or installations that experience high loads or heavy usage.

### Example 2

The following is a preferred low shrinkage cement that utilized in the formulation of Example 1, with the following components being in parts by weight:

| component | parts |
|---|---|
| sulfoferritic cement | 40-50 |
| mortar sand | 35-45 |
| water | 15-17 |

The water/solid phase ratio is from 0.7 to 0.19. Again, a high strength, highly durable material is created.

### Example 3

In an advantageous alternative, a plasticizer in an amount of about 0.3% in terms of dry matter of the weight of the cement used is added to the composition of Example 2. This makes the formulation more fluidic and facilitates installation, particularly when the formulation is to be gunited upon a surface to be repaired.

### Example 4

Another low shrinkage cement that can be used in the formulation of Example 1 is one having a maximum expansion ratio of 0.3% that is based on aluminate slags having the following components (wt. %):

| component | parts |
|---|---|
| 3CaO × SiO₂ | 60 |
| 2CaO × SiO₂ | 17 |
| 2CaO × Al₂O₃ | 5 |
| 4CaO × Al₂O₃ × Fe₂O₃ | 16 max. |
| SO₃ | 3-4.3 |
| Al₂O₃ | 5-6.5, |

Again, a high strength, highly durable material is created.

### Example 5

Another low shrinkage cement that can be added to the formulation of Example 1 is a sulfoferritic cement having an expansion ratio of not more than 0.3% and featuring the following components (wt. %):

| components | parts |
|---|---|
| 3CaO × 3Fe₂O₃ × CaSO₄ | 20 |
| 2CaO × Fe₂O₃ × CaSO₄ | 20 |
| 2CaO × SiO₂ | 30 |
| 6CaO × Al₂O₃ × 2Fe₂O₃ | 20 |
| 3CaO × SiO₂ | 10 |

Again, a high strength, highly durable material is created.

### Example 6

The cements of Examples 2-5 may also contain, apart from the amount of cement, the following components:

mortar sand taken in an amount of from 35 to 45 wt. %

cement setting promoter taken in an amount of from 1 to 5 wt. %

water taken in an amount of from 10 to 15 wt. %

Again, the water/solid phase ratio of the cement mortar used is between about 0.17 and 0.19.

As noted above, the cement may also incorporate a plasticizer, such as an aqueous solution of condensation products based on formalin/melamine and sodium nitrosulfate taken in a maximum amount of 0.7% of the weight of cement. The water/solid phase ratio in terms of dry matter is preferred at 0.15 to 0.17.

### Example 7

It is also possible to provide other formulations utilizing the concrete materials of this invention combined with other materials. For example, the present materials can be mixed with various other cementitious materials in a weight ratio of between about 3:1 and 1:3 to form other cementitious formulations for use as building materials, streets, parking garage and bridge decks, and the like. The cementitious materials to be added include the formulations of Examples 2-6 both as a portion of the formulation of Example 1 and as a separate cement material that can be mixed, e.g., in a 1:1 ratio, with the formulation of Example 1. The resulting formulations are preferred for use as new construction materials rather than as patching or repair materials.

In view of the foregoing, one of ordinary skill in the art is taught how to combine components in a manner such that a wide variety of repair or restoration materials can be provided, or new installations can be made with concrete materials that have enhanced properties so that the resulting installations will provide longer service lives that conventional materials, particularly in applications which are subject to high stress loadings or high service demands. Accordingly, the invention should not be limited to the preferred embodiments disclosed herein but only by the true spirit and scope of the appended claims.

What is claimed is:

1. A concrete material comprising:
an elastomeric polymer in an amount sufficient to provide flexibility to the resultant material;
a cement that has low shrinkage and expansion properties;
a silicone resin in an amount sufficient to improve adhesion between the elastomeric polymer and the cement;
a filler; and
water in an amount sufficient to cure the cement and form the concrete material;
wherein the polymer fills at least some of the pores in the material and helps the polymer bond the filler to the cement.

2. The concrete material of claim 1 wherein the elastomeric polymer is one that is in liquid form and that is reactive with the cement or water that is included in the material, and is present in an amount of about 4 to 14 percent by weight based on the weight of the material.

3. The concrete material of claim 2 wherein the elastomeric polymer is a polysulfide polymer or a polyurethane polymer and sufficient pores are filled with the polymer so that material has a porosity of between 2 and 20%.

4. The concrete material of claim 1 wherein the cement has an expansion rate of less than about 0.5% and is an alumina, sulfoalunima, or sulfoferritic cement and is present in an amount of about 4 to 17 percent by weight based on the weight of the material.

5. The concrete material of claim 1 wherein the silicone resin is present in an amount about 0.1 to 1 percent by weight based on the weight of the material.

6. The concrete material of claim 1 wherein the filler comprises sand and is present in an amount of about 60 to 91 percent by weight based on the weight of the material.

7. The concrete material of claim 1 which further comprises a curing agent for the elastomeric polymer in an amount of between about 0.1 and 0.5 percent by weight based on the weight of the material.

8. The concrete material of claim 7 wherein the curing agent is a bichromate of an alkali or alkaline earth metal, alone or in combination with at least one transition metal oxide.

9. The concrete material of claim 1 wherein the water is present in an amount sufficient to provide a water to cement weight ratio of about 0.05 and 0.1.

10. A concrete material property improving additive comprising a polymer admixture comprising an elastomeric polymer, a silicone resin and at least one solvent in an amount sufficient to form a viscous flowable mass of the admixture.

11. The additive of claim 10 wherein the elastomeric polymer is present in the admixture in an amount between about 70 to 98% by weight while the silicone resin is present in the admixture in an amount of about 2 to 30%.

12. The additive of claim 10 wherein the solvent comprises a mixture of aromatic and aliphatic solvents, and the admixture has a temperature of between about 30° C. to 60° C.

13. A concrete material comprising a cement component and the additive of claim 10 in an amount sufficient to improve the flexibility of the cement component; wherein the polymer fills at least some of the pores in the material and at least partially bonds the filler to the cement.

14. The concrete material of claim 13 wherein the cement component is an alumina, sulfoalunima, or sulfoferritic cement.

15. The concrete material of claim 13 wherein the cement component is present in an amount of about 40 to 50 percent by weight and the concrete material further comprises a filler in an amount of about 30 to 45 percent by weight.

16. The concrete material of claim 15 wherein the filler comprises sand and the cement component further comprises water in an amount of about 1 and 25% by weight.

17. A method of forming a concrete material which comprises preparing a mixture of the additive of claim 10 with a cement that has low shrinkage and expansion properties, a filler, and water in an amount sufficient to cure the cement; and curing the mixture to form the concrete material.

18. The method of claim 17 which further comprises including a curing agent for the polymer to assist in curing of the mixture.

19. The method of claim 18 wherein the curing agent is present in an amount of between about 0.1 and 0.5 and preferably between about 0.2 and 0.3 percent by weight based on the weight of the material, and is a bichromate of an alkali or alkaline earth metal, alone or in combination with at least one transition metal oxide.

20. The concrete material provided by the method of claim 17.

21. A method of repairing a crack or fracture in a concrete or cement surface which comprises cleaning surfaces of the crack or fracture to remove loose material and to create a cavity, applying the concrete material of claim 1 under pressure into the cavity, and allowing the concrete material to cure to repair the crack or fracture.

22. The method of claim 21 wherein the pressure applied to the concrete material is at least about 400 Kg/cm².

23. The method of claim 21 which further comprises applying a primer to the cleaned surfaces of the cavity before applying the concrete material into the cavity.

24. The method of claim 23 wherein the primer is a polysulfide material and is applied in an amount sufficient to enhance the bonding of the concrete material to the surfaces of the cavity.

25. The repaired crack or fracture in a concrete or cement surface which is obtained from the method of claim 21.
